(19) United States
(12) Patent Application Publication
(10) Pub. No.: US 2014/0019382 A1
(43) Pub. Date: Jan. 16, 2014

(54) Means by which to exercise fiduciary duty in transacting business via a self-selection process

(71) Applicant: Dennis F. Mahoney, West Chester, PA (US)

(72) Inventor: Dennis F. Mahoney, West Chester, PA (US)

(21) Appl. No.: 13/986,688

(22) Filed: May 25, 2013

Related U.S. Application Data
(63) Continuation-in-part of application No. 13/507,647, filed on Jul. 16, 2012, now Pat. No. 8,452,685.

(51) Int. Cl. G06Q 40/04

(52) U.S. Cl. CPC G06Q 40/04
USPC 705/36 R

(57) ABSTRACT

A process by which a psychometric test is embedded within the sequence of steps for completing an e-commerce transaction, determining knowledge of and competency regarding the product or service offering, using performance scores from a psychometric testing instrument to determine whether individual or group self-selectors understand the risks of their e-commerce choices. The purpose of inserting the psychometric test as a condition for limiting, expanding, restricting, or recommending a certain array of choices is to appropriately exercise fiduciary oversight and, in so doing, reduce or eliminate fiduciary and/or other forms of liability for the vendor, provider, distributor or other party offering products, services, and/or access to content or any other form of digital media. As an individual's score increases on the test, a larger array of choices become available allowing greater opportunity for e-commerce product, service or advise customization. This screening process benefits the individual or group engaging in self-selection by limiting choices where risks are not properly understood. Additionally, the use of the test as a screener to curtail unsuitable choices affords providers and other parties a mechanism to demonstrate that they have properly exercised their fiduciary or other duties when offering e-commerce self-selection.

### CROSS-REFERENCE TO RELATED APPLICATIONS

This application is a continuation-in-part of application Ser. No. 13/507,647, filed Jul. 16, 2012, now U.S. Pat. No. 8,452,685 granted May 28, 2013 which was a continuation of application Ser. No. 12/079,119, filed Mar. 25, 2008, now U.S. Pat. No. 8,224,732 granted Jul. 17, 2012. The patent applications identified above are incorporated here by reference in their entirety to provide continuity of disclosure.

### DESCRIPTION

### Field of the Invention

This invention relates to the field of e-commerce and, in particular, to methods for primarily reducing fiduciary liability and potentially other forms of liability for various commercial enterprises when permitting individuals or groups to self-select product or service offerings made available via the Internet or via a computer or display and input device.

### BACKGROUND OF THE INVENTION

Increasingly compensation and employee benefit plans have permitted employees to make choices and selections as to the form that their compensation and employee benefit coverage takes. This is true of health and welfare plans where such programs as flexible benefit plans under Section 125 of the Internal Revenue Code are permitted, and in the retirement planning area where employees select their own investments under self-directed defined contribution plans. In the retirement savings area, many employers have moved away from defined benefit plans to defined contribution plans. Within these defined contribution plans, many of which involve Section 401(k), Section 403(b) or Section 457(b) arrangements, employers permit employees to select their own plan investments. At the same time, the Employee Retirement Income Security Act (ERISA) of 1974 imposes fiduciary responsibilities on the employer sponsoring the plan, to assure the suitability of the various investment options at inception and to continue to monitor these investment options for their suitability on an ongoing basis. (For plans not specifically subject to ERISA-imposed fiduciary liability, many of these plans will follow the precepts and legal principles established by ERISA plans as models of “best practices.” This would be true of governmental plans and church plans that are exempt from ERISA-imposed fiduciary requirements. Accordingly, the invention described in this patent application would also have relevance to these non-ERISA plans as a “best practice” or under general trust law for assuring the best interests of plan participants even if a plan is not subject to ERISA under the law.)

In recent years, the extent to which an employer must exercise “due diligence” with monitoring investment suitability has been a subject of judicial review. Fiduciaries are required to act prudently in selecting and monitoring plan investments. With the transformation of the private pension system to one where employees make decisions regarding their own plan investments, other issues such as what an employer can do to facilitate investment education and who is able to provide investment advice have been undergoing major change.

The extent to which a plan sponsor must exercise “due diligence” regarding participant—directed plan investments was clarified in litigation tied to the massive bankruptcy of the Enron Corporation. The legal citation for this case is: Enron Corporation Securities, Derivative and ERISA Litigation, 284 F. Supp. 2d 511 (S. D. Tex. 2003). The decision by Judge Harmon, the presiding judge in the case, along with the “friend of the court” brief filed by the Department of Labor (DOL) clarified the fiduciary responsibilities of plan sponsors for participant-directed investments in an ERISA plan.

As statutorily determined under ERISA, the trustee or named fiduciaries of a plan are responsible for the investment of plan assets. [See ERISA ss405(c)] The trustee or named fiduciaries may appoint an investment manager (as defined in ERISA Section 3(38)), which will relieve the fiduciaries of responsibility for managing the investments, [see ERISA ss4 05(d)] but they must prudently select and monitor the manager. Section 404(c) of ERISA provides a procedure under which fiduciaries may be relieved of liability for losses resulting from a participant's exercise of control over his or her own account. To obtain 404(c) relief, the plan must comply with roughly 20 requirements found in the DOL regulation.

In her decision, Judge Hannon stated: “If a plan does not qualify as a 404(c) [plan], the fiduciaries retain liability for all investment decisions made, including decisions by the Plan participants.” [emphasis added] This decision by Judge Harmon was aligned with the “friend of the court” brief filed by the DOL in the Enron case which stated:
The only circumstance in which ERISA relieves the fiduciary of responsibility for a participant-directed investment is when the plan qualifies as a 404(c) plan under ERISA ss404(c) . . . a fiduciary is not liable for losses to the plan resulting from the participant's selection of investments in his own account, provided that the participant exercised control over the investment and the plan met the detailed requirements of a Department of Labor regulation.

Below is cited commentary by an expert on fiduciary liability explaining the implications of this landmark judicial decision on fiduciary liability issues for employee benefit plan sponsors:
What the Enron decision emphasizes is these responsibilities apply even to investment decisions made by the participants with respect to their own accounts—unless the plan complies with the requirements of ERISA Section 404(c). This is a powerful statement, because, for participant-directed plans, it places the responsibility for the prudence of participant investment decisions on the fiduciaries. Why? Because, in our experience, few plans actually comply with the requirements for 404(c) protection. It is commonly understood that fiduciaries remain responsible for selecting the investment options in participant-directed plans. Many fiduciaries, and most advisors, also know that fiduciaries can only be relieved of responsibility for the investment of participant accounts if the participants actually exercise investment control. What has not been commonly understood is that the fiduciaries can only be relieved of liability for participant investment decisions if the plan meets the detailed requirements of the DOL's 404(c) regulations. [DOL Reg.ss2550 404(c)-1; . . . ]

Put another way, the fiduciaries remain responsible for the prudence of the participant investment decisions even though the participants make the decisions. Merely allowing participants to decide how to invest their own accounts is not enough; the fiduciaries must take steps to ensure that the plan provides a broad range of investment options, provides the participants with the opportunity to exercise control over their accounts, and provides the participants with information sufficient to enable them to make informed investment decisions. And that must be done in a way that satisfies the 20 or so specific requirements in the regulation. If these requirements are not met, the fiduciaries are charged with the responsibility for the participants' decisions. Needless to say, this strongly reinforces the importance of complying with the 404(c) requirements—and the need to provide an investment structure that supports well-invested participant accounts (such as age-based life cycle or risk-based life style funds, managed accounts, or asset allocation models). (Reish, pp. 3-4, Lessons from the Enron Litigation)

Until the legal clarifications were made in the previously stated court case, the extent to which a plan sponsor or fiduciary possesses fiduciary liability for participant-directed plan choices was not fully understood and appreciated by most plan sponsors. Now as plan sponsors become aware of their potential liability exposure in these areas, they will look to find business methods that decrease or avoid such liability. As recommended by the expert (Reish) on fiduciary liability, several approaches are available to support the goal of an investment structure that supports well-invested participant accounts. One such approach suggested above is using an asset allocation model. Here an individual would determine an asset allocation approach that incurs the amount of risk he or she is willing to accept consistent with the risks and returns that various asset classes have exhibited historically.

Another approach would entail use of a risk-based life style fund. A risk based life style fund is a single fund or fund of funds whose asset allocation weightings are determined by how much risk an individual seeks to incur. One might select from a “conservative,” “moderate,” or “aggressive” allocation. Typically the “aggressive” allocation would have the largest weighting in equities. These funds free investors from having to rebalance their portfolios over time if they have selected a particular amount of risk they seek to incur. The portfolio manager would automatically rebalance the portfolio to preserve the asset allocation consistent with the risk preference initially selected.

Another approach suggested above is an age-based lifestyle fund. These types of funds are also called target date retirement funds. “Target date retirement funds are the most important 401(k) product development initiative to come along in the last ten years, and I give credit to Fidelity (Investments) for pioneering this concept with the introduction of the Freedom Funds targets in October of 1996 . . . Target date funds are no more than any other asset allocation or a life cycle fund with two rather uncomplicated twists: (a) the fund has wisely been ‘labeled’ to correspond with an anticipated year of retirement, and (b) rather than keeping the allocation static, the fund's equity exposure gradually slides down a ‘glide path’ over time.” (Malone, p. 1 Mar. 23, 2006)

Yet another approach would be to use a managed account. With a managed account, an investment manager would look to manage investments consistent with pre-determined risk levels that are made known to investors. Some investment professionals have actually suggested use of a questiorinaire to determine risk preference and then manage multiple accounts that would tailor investments in those specific accounts to the identified risk preferences of investors. This approach would avoid participants directing their own investments and leave the investing responsibilities with the investment manager selected by the plan sponsor. (Chang, Simon, and Allen, 2005)

Although many of the aforementioned investment structures have significant advantages, they also have certain disadvantages. A primary and significant disadvantage common to all of the aforementioned investment structures is that they curtail the ability of the individual participant to select investments that he or she expects will provide the best investment return given his or her individual risk profile. For the knowledgeable investor, the ability to self-direct one's plan investments holds significant appeal. All of these other suggested investment structures serve to limit fiduciary liability exposure for the plan sponsor, but in doing so, restrict the freedom of the individual plan participant to customize his or her benefit plan.

Following the Enron decision, another court case was decided involving a plan sponsor that did not qualify for 404(c) protection. In this decision, (Jenkins v. Yager & Mid America Motorworks, Inc., No. 04-4258 7^{th} Circuit, Apr. 14, 2006), it was held that ERISA section 404(c) is only a safe harbor and the actions of the plan trustee, when delegating decision-making authority to plan participants, must be evaluated to see if they violate a trustee's fiduciary duty. In Jenkins v. Yager & Mid America Motorworks, Inc., the Court found that “Mr. Yager provided his employees with the necessary information to enable them to direct their investments in the 401(k) Plan, including by holding yearly meetings with a financial advisor to discuss investments in the 401(k) Plan.”(White & Case, p. 3) The significance of the Yager decision is that it allows plan sponsors to prove they did not violate a trustee's fiduciary duty if they take proactive steps that are beneficial to participant decision-making. The suggested invention provides a means for a plan sponsor or fiduciary to limit fiduciary liability exposure while preserving the ability of the individual participant to customize his or her benefit plan.

Following passage of the Pension Protection Act of 2006 (PPA), enacted into law in August of 2006, the Department of Labor (DOL) issued guidance concerning default investments in participant directed individual account plans. The following background and guidance was provided:
“With the enactment of the PPA, section 404(c) of ERISA was amended to provide relief afforded by section 404(c)(1) to fiduciaries that invest participant assets in certain types of default investment alternatives in the absence of participant investment direction. Specifically, section 624(a) of the PPA added a new section 404(c)(5) to ERISA. Section 404(c)(5)(A) of ERISA provides that, for purposes of section 404(c)(1) of ERISA, a participant in an individual account plan shall be treated as exercising control over the assets in the account with respect to the amount of contributions and earnings which, in the absence of an investment election by the participant, are invested by the plan in accordance with regulations prescribed by the Secretary of Labor. Section 624(a) of the Pension Protection Act directed that such regulations provide guidance on the appropriateness of designating default investments that include a mix of asset classes consistent with capital preservation or long-term capital appreciation, or a blend of both. In the Department's view, this statutory language provides the stated relief to fiduciaries of any participant directed individual account plan that complies with its terms and with those of the Department's regulation under section 404(c)(5) of ERISA. The relief afforded by section 404(c)(5), therefore, is not contingent on a plan being an ‘ERISA 404(c) plan’ or otherwise meeting the requirements of the Department's regulations at ss 2550.404c-1. The amendments made by section 624 of the Pension Protection Act apply to plan years beginning after Dec. 31, 2006.

On Sep. 27, 2006, the Department, exercising its authority under section 505 of ERISA and consistent with section 624 of the Pension Protection Act, published a notice of proposed rulemaking in the Federal Register (71 FR 56806) that, upon adoption, would implement the provisions of ERISA section 404(c)(5).”(Federal Register (29 CFR Part 2550, p. 60452)

The final rules were published in the Federal Register on Oct. 24, 2007 and these final rules had an effective date of Dec. 24, 2007. It is not entirely certain as to the effect of these relatively recently issued final rules on default investments on the implementation and use of the invention in this patent application. It is believed by the inventor that the use of this invention may be integrated within the enrollment and ongoing monitoring functions of a plan sponsor and be compatible with the rules of default investments.

The invention described in this patent application is particularly timely. On Feb. 20, 2008, the U.S. Supreme Court decided the case of LaRue v. DeWolff Boberg & Associates, Inc., et al. This case clarified that individual participants in 401(k) and other retirement plans subject to ERISA have standing to sue plan fiduciaries to recover investment losses from their accounts. Previously when the Supreme Court decided the case of Massachusetts Mutual Life Insurance Co. v. Russell, it had held that individual participants could not bring an ERISA claim “to recover consequential damages,” but could only seek recovery by “the plan as an entity.” LaRue renders this prior holding irrelevant and permits a plan participant to pursue “damages” to the plan, even where measured solely by the injury to the plan participants' individual accounts (Thompson Hine, p. 1). This important case was reported in The New York Times, Wall Street Journal, and the Washington Post newspapers on Feb. 21, 2008. (New York Times, pp. 1-2, Wall Street Journal, p. D1, and Washington Post, p. A01). This precedent-setting case is likely to result in increased litigation against plan sponsors by plan participants. Accordingly, the invention described in this patent application may assist plan sponsors in avoiding such litigation.

Employees who have been defaulted into investment choices may be particularly at risk should a market downturn occur, particularly if they are not well-informed investors. If invention is used as part of the enrollment process, it may protect less well-informed investors from fleeing beneficial long-term default investments prematurely when market corrections occur.

Currently there are various administrative record-keeping systems for processing benefits transactions. The patent to El-Kadi and Derienzo (U.S. Pat. No. 6,014,642) relates to a system for processing investment information, participant data and financial transactions with respect to employee benefits programs. Similarly, there are systems that provide for tracking and accounting of plan choices. The patent to Gilbert and Gupta (U.S. Pat. No. 6,041,313) relates generally to the field of computer-based retirement plan tracking and accounting with specific application to a modified 401(k) retirement plan. There have also been patents disclosing inventions that serve to allow investors to screen investments for appropriateness and that allow investors to assess their personal financial risk tolerance. The invention in a patent of Maggioncalda, Jones, Sharpe, Fine, and Tauber (U.S. Pat. No. 5,918,217) allows a user to explore how changes in risk tolerance, savings level and retirement age affect the probability of achieving one's financial goal. The patent of Davey (U.S. Pat. No. 6,859,788) discloses a method and system for the automated assessment of personal financial risk tolerance. The patent of Rebane (U.S. Pat. No. 6,078,904) discloses a system for optimally allocating investment funds of an investor in a portfolio having a plurality of investments.

The field of psychometrics has produced various types of testing instruments to ascertain measures of knowledge, aptitudes and proficiency. The patent of Penno (U.S. Patent No. 6,705,870) discloses one such example. Some of these methods involve computer-implemented methods such as the method disclosed in the patent of Calhoun, Peterson and Merzenich (U.S. Patent No. 6,565,359) which relates to a computer-implemented method and apparatus for remote cognitive and/or perceptual testing. Some of these methods and apparatuses provide a means of training as well as testing. The patent of Breznitz (U.S. Pat. No. 6,632,174) discloses a method for testing and/or training cognitive ability. Some of these testing and training instruments involve a simulation or case study. The invention in a patent of Gray and Coons (U.S. Pat. No. 6,944,596) makes use of an education business simulation. Some testing and training approaches make use of a technique known as adaptive testing. The invention in a patent of Moore, Cleveland, Vulfs, Carter, Cahill, and Heinz (U.S. Pat. No. 6,925,601) uses an adaptive testing tool. Once any type of cognitive or psychological test is administered, there usually is a method to record and retain performance. The patent of Poreh (U.S. Pat. No. 6,629,846) discloses a method for recording performance in psychological tests.

Although various types of psychometric testing instruments exist, they have not been used in conjunction with compensation and benefit plan enrollment systems to determine whether plan participants possess sufficient knowledge or capability to make certain plan choices. In accordance with my invention, using a measure of performance on a psychometric testing instrument to determine an array of either recommended plan selections or allowable choices under a plan protects plan participants and their beneficiaries. My inventive business method also allows plan sponsors to limit fiduciary liability and proactively fulfill their fiduciary responsibilities.

### Additional Description Relevant to Continuation-In-Part Application:

It is helpful to further explore details regarding fiduciary duties as prescribed by law:
“A fiduciary duty is an obligation to act in the best interest of another party. A fiduciary obligation exists whenever the relationship with the client involves a special trust, confidence, and reliance on the fiduciary to exercise his discretion or expertise in acting for the client. The fiduciary must knowingly accept that trust and confidence to exercise his expertise and discretion to act on the client's behalf . . . The client is entitled to the best efforts of the fiduciary on his behalf and the fiduciary must exercise all of the skill, care and diligence at his disposal when acting on behalf of the client. A person acting in a fiduciary capacity is held to a high standard of honesty and full disclosure in regard to the client and must not obtain a personal benefit at the expense of the client.” (Breach of Fiduciary Law & Legal Definition 1)
“Fiduciary duties fall into two broad categories: the duty of loyalty and the duty of care. These duties vary with different types of relationships between fiduciaries and their counter-parties ('entrustors').
Arrangements in which entrustors are precluded from controlling their fiduciaries in the performance of their services, categorized in law as ‘trust,’ vest far more power in the fiduciaries than arrangements, categorized in law as ‘agency,’ in which entrustors control their fiduciaries in the performance of their services . . .
The sole purpose of entrustment is to enable fiduciaries to serve their entrustors. Entrustment enables fiduciaries to use entrusted power for other purposes for their own use or the use of third parties . . . (Frankel, 127)

Electronic commerce, commonly known as e-commerce, presents some special challenges in terms of fiduciary duties. A precise definition of e-commerce is sometimes elusive. One account defines electronic commerce as follows:

“Electronic commerce, commonly known as e-commerce, is a type of industry where buying and selling of product or service is conducted over electronic systems such as the Internet and other computer networks. Electronic commerce draws on technologies such as mobile commerce, electronic funds transfer, supply chain management, Internet marketing, online transaction processing, electronic data interchange (EDI), inventory management systems, and automated data collection systems. Modern electronic commerce typically uses the World Wide Web at least at one point in the transaction's life-cycle, although it may encompass a wider range of technologies such as e-mail, mobile devices, social media, and telephones as well.

Electronic commerce is generally considered to be the sales aspect of e-business. It also consists of the exchange of data to facilitate financing and payment aspects of business transactions. This is an effective and efficient way of communicating within an organization and one of the most effective and useful ways of conducting business. E-commerce can be divided into:
E-tailing or “virtual storefronts” on websites with online catalogs, sometimes gathered into a “virtual mall”
The gathering and use of demographic data through Web contacts and social media
Electronic Data Interchange (EDI), the business-to-business exchange of data
E-mail and fax and their use as media for reaching prospective and established customers (for example, with newsletters)
Business-to-business buying and selling
The security of business transactions.” (Wikipedia, E-commerce entry, May 17, 2013)

E-commerce presents some special challenges regarding its ability to give rise to fiduciary duties and resultant fiduciary liability. “As with fiduciary relationships generally, not all of the various aspects of e-commerce relations may be properly characterized as fiduciary. When a user visits a website, searches through its offerings, and ultimately purchases goods, each element of that user's visit may generate different legal obligations. The characterization of the legal obligations that may be found to exist will be dependent upon any representations or warranties made by the operator, the presence or absence of exculpatory clauses or other liability limiting devices, or the existence of user queries and the responses thereto.” (Palmer 73)

“While it is not possible to establish the fiduciary nature of any interaction in the absence of specific facts, there is nothing inherent in e-commerce relations that would preclude them from being described as fiduciary. Fiduciary law's goal of maintaining the integrity of socially and economically important or necessary relations would appear to be particularly relevant to the relationships created under the auspices of e-commerce and the potential for harm created therein, particularly with respect to the collection and use of user information. Certainly the need to promote confidence in potential and existing users to facilitate and maintain their participation in e-commerce would make fiduciary principles attractive to achieve such ends.

Fiduciary law could, conceivably, provide a method of regulating e-commerce that is neither rooted in nor controlled by private parties or government, but is directed by the goal of fostering trust and confidence propounded by both. Moreover, it would not need to displace existing common law or statutory regimes to operate, but would work alongside them, providing its assistance where it would be both necessary and appropriate to the task.

Pursuing fiduciary regulation of e-commerce would not create the difficulties associated with the creation, ratification, and domestic implementation of international agreements and protocols. Fiduciary law's application across jurisdictional boundaries offers another practical legal basis to prefer it to other alternatives for regulating e-commerce. Moreover, the doctrinally-similar, if not identical, application of the fiduciary concept in jurisdictions emanating from the English legal tradition and many civil law jurisdictions traceable to Roman law provides it with a wider, complementary jurisdictional authority to entertain e-commerce disputes than domestic legislation.

Fiduciary law's application to e-commerce is potentially adoptable also in those jurisdictions that view law and Equity as possessing different, though complementary functions, even if they do not share a common history with English or Roman legal traditions. This is so because the fiduciary concept's application to existing methods of regulating e-commerce serves to ameliorate the harshness of the common law and to fill in its gaps in the manner that Equity does alongside the common law.

An effective legal regime must balance its need for certainty with an appropriate measure of flexibility and discretion. The working arrangement between law and Equity provides both the establishment of fundamental notions of justice in absolute terms—which has the effect of maintaining the objectivity and legitimacy of law—while retaining the necessary flexibility within its application to specific circumstances to avoid inappropriate and excessive rigidity—which would detract from the legitimacy of the law. For e-commerce, positive laws of contract and privacy legislation are necessary to generate reasonable or legitimate modes of conduct based upon ascertainable standards. Yet, they do not adequately address all of the concerns raised by e-commerce. This is where fiduciary law fits as a means to address these additional concerns that remained untouched by the common law. The law governing e-commerce may thereby maintain its appropriateness in a wide variety of circumstances . . . ” (Palmer 74)

### SUMMARY

In accordance with my invention, a psychometric test is placed in the chain of mandatory steps that comprise the requirements to consummate or complete a business transaction. The psychometric test determines understanding of various options, serves to measure acceptable knowledge and competence to make e-commerce selections and then as one possible intervention limits access to e-commerce options based on the test outcome. Inability to demonstrate certain levels of mastery results in an individual having to re-test, engage in certain education or training before re-testing, obtaining proof of competent assistance in making e-commerce choices, or being defaulted into another appropriate e-commerce option; thus reducing fiduciary or other forms of risk to the vendor, or distributor, making the e-commerce offering. Demonstration of greater proficiency on the test permits a wider array of e-commerce choice. Access to a wider array of e-commerce choice allows for greater individual customization to tailor the program to the individual's risk preferences and desired requirements. As an alternative to actually limiting e-commerce options, a vendor or provider may merely recommend that a self-selector restrict their choices to a universe of e-commerce choices aligned with the self-selector's capability as demonstrated by test performance.

Accordingly several advantages of the invention accrue to both self-selectors and vendors, providers, distributors, or other parties making available choices through self-selection. In a preferred embodiment of the invention, self-selectors are denied access to e-commerce-selected features and/or product or service offerings where they lack sufficient knowledge of the option or its related risks. In that way, the invention serves to limit unforeseen risk to self-selectors as well as the vendors they do business with. For the vendor, provider, distributor, or other party making available offerings through self-selection; the use of this invention provides an added safeguard or protection for its customers or self-selectors that restricts access to features the self-selector fails to understand and which may be inappropriate e-commerce choices for said individual or group who is self-selecting. Use of the invention also serves to limit fiduciary and potentially other forms of liability for the provider potentially resulting in lowered legal costs and avoidance of fiduciary or other legal claims and direct legal fees associated with litigating such claims. Use of the invention also may reduce premium costs associated with insurance provided by insurers to the vendor, provider, distributor, or other party making available offerings through self-selection. In addition to the advantages of the invention for the self-selectors and providers of e-commerce product and service offerings, the invention provides a feature that holds value for insurance companies that provide insurance for various fiduciary, contractual and/or product liability claims. Presumably this mechanism and screening method reduces the prevalence of such claims. Finally, the invention furthers the public policy objective of protecting the integrity and reliability of e-commerce by providing a mechanism for fiduciary oversight by those offering products or services via e-commerce. This “gate-keeping” mechanism should safeguard and improve the integrity of e-commerce furthering its use and legitimacy in selling, renting or providing access to content or digital media that demands an oversight function or stewardship role on the part of the vendor, provider, distributor, or other party making available offerings through self-selection.

### BRIEF DESCRIPTION OF THE DRAWINGS

FIG. 1 is a macro-level diagram illustrating potential provider approaches to reduce or eliminate fiduciary and other forms of liability exposure by using a psychometric testing instrument in accordance with my invention. FIG. 1 shows broad approaches providers and others may use. Providers and others may use the testing instrument to recommend a universe of choices a self-selector should select within, or the provider may take a more restrictive “gatekeeper approach” and actually restrict the universe of available e-commerce choices based on an individual's or group's performance on the psychometric testing instrument.

FIG. 2 is a flowchart showing how the business method for e-commerce selections and transactions occurs in accordance with my invention when the performance on a psychometric testing instrument is used to actually limit the array of acceptable e-commerce choices and executable transactions made available to the individual or group involved in self-selection.

### DETAILED DESCRIPTION—PREFERRED EMBODIMENT

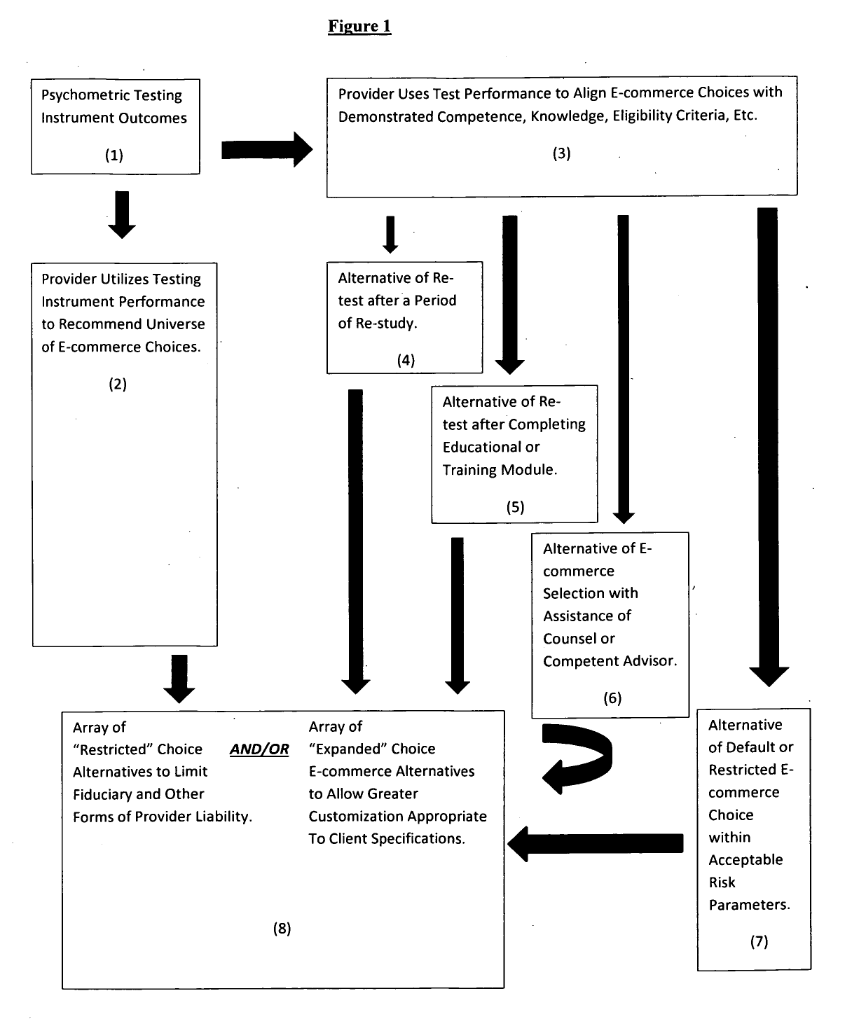

### FIG. 1: Use of Psychometric Testing Instrument to Limit Fiduciary and Other Forms of Liability

FIG. 1 is a flowchart depicting alternative actions that a provider may take in an attempt to limit fiduciary and other forms of liability. Following the reporting of self-selector performance on the psychometric testing instrument at position 1, the provider may either recommend a universe of acceptable selections moving to position 2 or use the more restrictive approach of actually limiting e-commerce choices by moving to position 3. (Alternatively, hybrid approaches also may be used where a provider makes recommendations as noted at position 2, but uses a more restrictive policy as indicated at position 3 if scores on the psychometric test are below a certain level.)

### Position 2: “Merely Recommending” Broad Categories of E-Commerce Self-Selector Choices:

In keeping with the path of position 2, a provider may recommend that a self-selector choose between a certain choice or a menu of choices (Column A at position 8). A provider may choose to offer the menu of default choices specifically identified as acceptable default choices. Alternatively, a provider may indicate that the self-selector has demonstrated an understanding of a more expanded array of e-commerce choices (Column B at position 8). It is important to realize that these are not recommendations, but merely counsel on seemingly appropriate choice based upon outcomes from the administration of the psychometric instrument. The vendor, provider, distributor, or other party making available offerings through self-selection is merely suggesting that the individual not move beyond the boundaries of his or her “circle of competence” if the test is providing evidence that the self-selector does not understand the e-commerce options or the risks that accompany these e-commerce choices.

Position 3: A “Gatekeeper Approach” where Choices are Limited Unless Competence is Demonstrated:

Following the more restrictive path of position 3, a provider or other party requires demonstrated competence in order to make certain e-commerce selections. If a provider or other party implements a policy whereby demonstrated competency is required to access various e-commerce choices, other policy decisions are required to determine whether the individual or group self-selector may use alternate paths to demonstrate competency. For instance, if a self-selector does not achieve a score that would allow access to the expanded array of e-commerce choices (Column B at position 8), he or she may be permitted to re-test after a period of re-study as indicated at position 4. Another alternative is to allow for re-testing after completion of an educational or testing module (position 5). Another alternative is to require e-commerce selection with the assistance of counsel (position 6). Another alternative shown at position 7 is to immediately default the self-selector after one testing attempt into a certain e-commerce choice or alternatively to allow choice within a limited array of e-commerce options (Column A at position 8) whose risk level is commensurate with the knowledge or ability demonstrated via test performance.

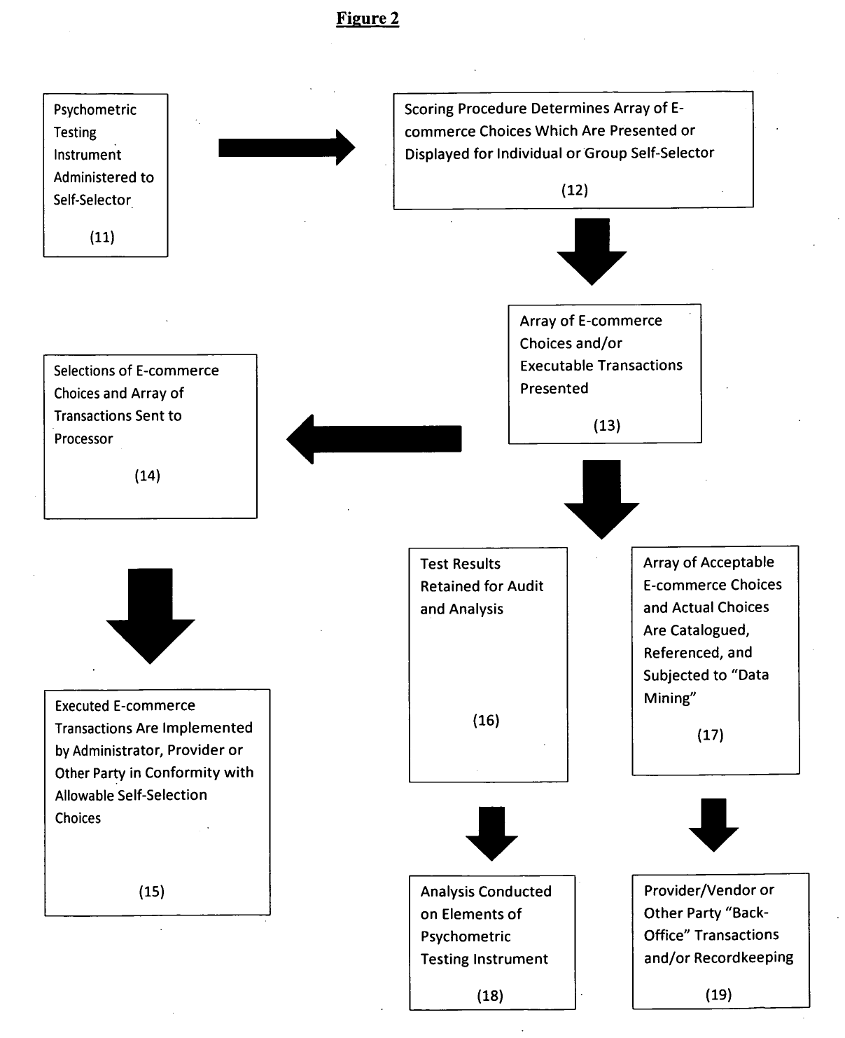

FIG. 2: Method to Align E-Commerce Choices with Demonstrated Competency

FIG. 2 is a flowchart of a business method that occurs when the psychometric test either defaults self-selectors into various e-commerce choices or provides an array of limited e-commerce choice. In FIG. 2 this business method begins with administration of the psychometric testing instrument to the self-selector occurring initially at position 11 before any e-commerce selections are chosen. Once the psychometric test is administered, the test undergoes a procedure where scoring occurs at position 12. Not only is a score computed for the psychometric test, but the level of the score then determines at position 13 the array of e-commerce choices for the individual or group self-selector to choose from. Lower scores on the psychometric test result in fewer and less risky e-commerce choices. Higher scores allow for an expanded array of e-commerce choices where self-selectors may customize their program to a greater extent and assume greater risk. In a particular preferred embodiment of my invention the choice is either a full array allowing maximum choice or the defaulted choice depending upon whether or not the self-selector passes the psychometric test. In this particular embodiment of my invention, essentially with a “Pass-Fail” measure on the psychometric test, there is either “Choice or No Choice” in the selection of e-commerce alternatives.

Once e-commerce selections are made, these choices are transmitted to the administrator or provider at position 14 for implementation at position 15. Also, when the individual or group self-selector takes the test, his or her individual test performance is retained at position 16 for future audit and analysis at position 18. The provider or other party also may retain the test-determined permissible e-commerce choices for the individual self-selector and his or her specific selections at position 17 to process any business transactions at position 19. If business transaction processing is out-sourced to a third-party administrator, this information may be communicated to the third party.

### REFERENCE NUMERALS

### FIG. 1 Reference Numerals:

01 psychometric testing instrument administered and outcomes received by administrator

02 provider uses test performance to recommend universe of e-commerce choices

03 provider uses test performance to align e-commerce choices with demonstrated competence, knowledge or eligibility criteria

04 alternative of re-test after a period of re-study

05 alternative of re-test after completing educational or training module

06 alternative of e-commerce selection with assistance of counsel

07 alternative of default or restricted e-commerce choice within acceptable risk parameters

08 array of restricted choice and expanded choice e-commerce alternatives

### FIG. 2 Reference Numerals:

11 psychometric testing instrument administered to individual or group self-selector

12 scoring procedure which determines array of e-commerce choices presented to individual or group self-selector

13 array of e-commerce choices and executable e-commerce transactions presented to individual or group self-selector

14 selections of e-commerce choices and array of transactions sent to administrator or processor post individual or group choice

15 executed transactions implemented by administrator, provider or other party

16 individual test results retained for future audit and analysis

17 array of acceptable e-commerce choices presented to self-selector and individual selections made by self-selector

18 information (i.e., group statistics) is aggregated on psychometric testing instrument so analysis on instrument can be conducted

19 transactions needed by provider/vendor or other party are executed by the provider/vendor or other party

### Operation—Preferred Embodiment

In operation, a self-selector takes the psychometric test prior to completing an e-commerce transaction; either before, during, or after the sequence of steps in the self-selection process. Alternatively, the provider or other party may run periodic reviews of e-commerce choices and request demonstration of competency should individual e-commerce choices indicate an undue risk profile or e-commerce selections that are inconsistent. Upon completion of the test, knowledge and competencies are assessed and scored. At this juncture a provider or other party may either recommend that an individual or group engaging in self-selection remain within a certain universe of choices, or use a gatekeeper approach where only certain e-commerce choices are offered. Either an overall score or selected sub-scores in relevant competency or content areas may be used to identify the acceptable array of e-commerce choices. Depending upon provider requirements and the advice of the provider's legal counsel, various alternative options may be presented to the self-selector. These possible options may include, but not necessarily be limited to, the following:
1. Re-test after a period of re-study.
2. Re-test after completing a specially designed educational or training module.
3. Provide a signed affidavit that competent counsel is being used to assist the self-selector in selection of an acceptable and appropriate e-commerce option.
4. Default the self-selector into an e-commerce option whose balanced characteristics mitigate risk or offer several risk-restricted choices.

An example of the operation of the psychometric test when paired with a profit sharing, 403(b) plan or 401(k) plan, may take the following form:

### Psychometric Test Administered:

1.) At hire or
2.) Prior to the first date of initial eligibility to participate in the plan, and
3.) Subsequently annually one month prior to the start of the plan year.

Upon outcome of test, the test administrator forwards acceptable plan options to the plan participant who makes selections from available plan choices. These choices may include the following options:
1.) A money market account
2.) An array of age-related balanced lifestyle funds, and the option shown in 1.) above
3.) An expanded array of mutual funds and exchange traded funds meeting minimal 404(c) investment choice requirements, plus options shown in 1.) and 2.) above
4.) A more expanded array of mutual funds and exchange traded funds, inclusive of the options shown in 1.) , 2.) and 3.) above, but adding even more options involving choices with greater historical risk and price volatility measures
5.) Option 4.) above, but with a brokerage window option offered where the plan participant may select individual stocks, bonds, commodities, options, etc.

As is evident from the previously described array of investment options, greater investment knowledge and sophistication is expected if the individual seeks to engage in investment strategies allowed in those options ascending to option 5.).

### Rules for Sample 401(k) Plan Choices:

Those who have failed to enroll in the plan by signing an application and who are subject to automatic enrollment in the plan may be defaulted into a selected option, such as Options 1, 2, or 3.
Those not achieving a minimal score for knowledge of investment options or portfolio construction may be restricted to either Options 1, 2, or 3.
Those achieving higher scores may choose the alternatives permitted in Options 1, 2, 3 and 4.
Those demonstrating achievement of the highest levels of knowledge and competency on the test may be permitted to select Options 1, 2, 3, 4, or 5.

Alternatively, plan rules may offer multiple plan options, but require certain threshold weightings within various asset classes. A variety of portfolio construction approaches may be possible. The key element in these various approaches is that the plan sponsor restricts the individual plan participant to investment choices that limit risk to an acceptable level determined by the plan sponsor. Greater risk and the potential for greater reward under a more customized program is only permitted when the plan participant provides evidence of knowledge and competency via improved performance on the testing instrument or seeks counsel from professional advisors.

### Description—Alternative Embodiment

Although the preferred embodiment of this invention describes a business method that may be implemented by a single provider for a single and independent business transaction, a more universal approach is also possible. A psychometric test may be used for testing knowledge and aptitudes concerning commonly offered products, services or related features or offerings. This more universal test or series of tests may be administered to self-selectors at any time. For instance, the test may be administered to prequalify for making future e-commerce choices. Test results from this more universal test may be used to reduce fiduciary or other forms of liability as done in the preferred embodiment of the invention described above. Accordingly, those results may be utilized to establish eligibility to purchase products or services, or to select the array of possible e-commerce choices offered to the self-selector at any time either currently or in the future. This more general approach may become popular if the practice of administering a psychometric test when selecting e-commerce choices becomes more widely used in commercial practice once introduced.

### Operation—Alternative Embodiment

Under the more universal embodiment described in the immediately preceding section, a provider may rely on a third party to administer a more universal test to its many clients concerning knowledge or competency. These scores may then be used to make recommendations or to offer options under the provider's e-commerce product or service offerings that are consistent with the test scores of the individual or group self-selectors. An advantage of this approach is that a much larger pool of more frequent test takers creates an ongoing business method where test questions may be tailored to recent environmental occurrences. A larger pool of test takers created by this embodiment also provides more statistical data on the specific test questions and the opportunity to develop and substitute more questions more frequently enhancing the overall relevancy and quality of the psychometric testing instrument. This more universal approach provides the advantages of added efficiencies and lowered costs in enhancing self-selector knowledge and/or competency, and in lowering provider or other party fiduciary, and potentially other forms, of liability.

What is claimed:

1. A computer implemented method of limiting a vendor's, producer's, distributor's, service provider's or any other individual's or entity's liability for inappropriately selling, renting, or in any way permitting use of or access to products, services, content, or digital media in any form via self-selection to a customer or third party comprising:
the interface and required steps within an automated business transaction in which completion and scoring of a computer implemented, valid psychometric instrument is inserted within the chain of required steps to effectuate the completed business transaction or limits or expands viable or permitted choices appropriately matched to outcomes or measures determined by the testing instrument;
scoring the psychometric test to obtain a test score;
mapping the test score to various possible options based upon the individual's or group's level of measured knowledge, demographic information and/or capabilities or characteristics demonstrated by the test;
allowing intervention or action as a result of the psychometric test score, including mapping of test attributes to product or service offerings, including access to content or digital media in any form;
limiting fiduciary liability by
displaying and allowing a party (or parties) engaged in self-selection to better understand the products, services, content, or digital media in any form offered through self-selection and/or
defaulting the individual or group into a certain course of action or alternative; and/or
executing via the computer, business transactions to make selections of alternatives or courses of action, or following of advice consistent with those options permissible based upon said test score and said individual or group selection.

2. The computer implemented method of claim 1, wherein the psychometric test includes test questions, or items, containing objective content material or tasks able to demonstrate appropriate characteristics or competencies that are relevant to the self-selection of product, service, content or digital media offerings in any form. The psychometric instrument whose completion is necessary as a prerequisite to proceed with the selection of a product, service, content or digital media; or whose administration and scoring determines the items to be offered as various alternative products or services is coupled with some type of self-service selection, access, rental or purchase choice either via the Internet or via a computer or display and input device; whereby the use of the valid psychometric instrument serves a “gatekeeper function” limiting the customer from selecting inappropriate, restricted, or potentially adverse choices and whose completion serves to provide evidence that the vendor, producer, distributor, and/or provider of the product or service has exercised a fiduciary and/or contractual duty to limit access or ability to procure the product or service when inappropriate, or has made an effort to appropriately customize or make available only products or services that are most appropriately matched to the individual's (or group's) valid requirements and/or permissible to be made available to the self-selector when engaging in the self-selection process.

3. The computer implemented method of claim 1, further including creating an array of options or alternatives, wherein aggregation of options or alternatives is grouped in such a manner as to create appropriate choices for the individual or group engaged in the self-selection process and/or to withhold certain or all choices or to present alternative choices as a result of test outcomes.

4. The computer implemented method of claim 1, wherein performance on content areas in the psychometric test is used to provide relevant information or an array of recommended or allowable options or alternatives.

5. The computer implemented method of claim 1, the engaging step comprising recommending that the individual choose within a certain universe of computer-generated choices or seek additional information from the individual or group engaged in the self-selection process when attempting to consummate a business transaction or access information.

6. The computer implemented method of claim 1, the engaging step comprising limiting the array of choices to select from depending on the test score or identifying issues or requirements which need resolution before completion of a business transaction may be permitted or before which access to information will be allowed.

7. A computer implemented method of screening or assessing an individual's or a group's characteristics which allow for completion of a business transaction and/or access to information comprising:
administering a psychometric test to an individual or group via a display and input device to determine relevant information regarding demographic characteristics and/or understanding of facts, concepts, learned items, knowledge, subject matter, competencies, abilities, standards, claimed understanding, agreements, representations, contractual terms, organizational policies, prescribed procedures, dangers, potential risks, assumption of risks, intended actions, likely or possible consequences or any other talent or type of dexterity or testable skill, knowledge or aptitude whose clarification and/or measurement could have relevance to either the intended completion of the business transaction, access to information and/or the provision of product(s), service(s) and/or content or digital media;
scoring the psychometric test to obtain a test score;
mapping the test score to various possible options and alternatives based upon the individual's or group's characteristics and/or level of measured knowledge and/or capabilities demonstrated by the test;
screening or assessing the individual's or group's agreement to terms, assumptions, understanding and/or representations regarding a product, service, content and/or digital media which could give rise to any disagreement, misunderstanding or any adverse or beneficial consequence and/or reputational impact based upon the individual's and/or group's characteristics, level of measured knowledge and/or capabilities demonstrated by the test;
allowing intervention or action as a result of the psychometric test score;
screening or assessing previously referenced characteristics by
displaying and allowing the individual or group being assessed to better understand the knowledge, skill set, expectations and/or understanding to proceed with the business transaction or access to information based upon the results of the administered psychometric testing instrument or
defaulting the individual and/or group into a certain course of action or alternative; and/or
executing via the computer, business transactions to make selections of alternatives or courses of action, or following advice consistent with those options or alternatives permissible based upon said test score and said individual or group selection,
whereby any party to the business transaction or informational request (i.e., vendor, producer, distributor, service provider or other individual, group or entity) can provide at least the test score as evidence of having exercised a fiduciary duty to disallow, restrict, modify, curtail and/or require additional information from the self-selecting customer before completing the business transaction or informational request.

8. The computer implemented method of claim 7 wherein the psychometric test includes test questions, or items, containing objective content material or tasks able to demonstrate competencies or solicit characteristic information that is (are) relevant to completion of the business transaction or informational request. The psychometric instrument whose completion is necessary as a prerequisite to proceed with the selection of a product, service, content or digital media; or whose administration and scoring determines the items to be offered as various alternative products or services is coupled with some type of self-service selection, access, rental or purchase choice either via the Internet or via a computer or display and input device; whereby the use of the valid psychometric instrument serves a “gatekeeper function” limiting the customer from selecting inappropriate, restricted, or potentially adverse choices and whose completion serves to provide evidence that the vendor, producer, distributor, and/or provider of the product or service has exercised a fiduciary duty to limit access or ability to procure the product or service when inappropriate, or has made an effort to appropriately customize or make available only products or services that are most appropriately matched to the individual's valid requirements and/or permissible to be made available to the self-selector when engaging in the self-selection process.

9. The computer implemented method of claim 7, further including creating an array of options or alternatives, wherein aggregation of these options or alternatives is grouped in such a manner as to be relevant to the business transaction or informational request that is being pursued.

10. The computer implemented method of claim 7 wherein performance on content areas in the psychometric test is used to provide relevant information or an array of recommended or allowable options and alternatives.

11. The computer implemented method of claim 7, the engaging step comprising recommending that the individual or group choose within a certain universe of computer-generated choices or seek additional information from the individual or group involved in self-selection.

12. The computer implemented method of claim 7, the engaging step comprising limiting the array of choices to select from depending on the test score or pointing to areas which require resolution before the business transaction can be completed or the informational request granted.

13. A computer implemented method of limiting an individual's or group's risks or liability which could give rise to any adverse or beneficial consequence and/or reputational risk or benefit comprising:
using an input and display device to administer a test and to obtain answers from an individual or group on characteristics, understanding of facts, concepts, learned items, knowledge, subject matter, competencies, abilities, standards, claimed understanding, agreements, representations, contractual terms, organizational policies, prescribed procedures, dangers, potential risks, assumption of risks, intended actions, likely or possible consequences or any other talent or type of dexterity or testable skill, knowledge or aptitude whose clarification and/or measurement could have relevance to whether a business transaction should be completed and/or an informational request granted; and
limiting fiduciary liability exposure or providing relevant information to amend the terms of the business transaction and/or informational request by displaying additional information and/or allowing selection of those options and alternatives determined to be appropriate for the individual or group based upon the answers to the test, or responsibly chosen with documentable advice provided by a competent advisor.

14. A computer implemented method of ascertaining characteristics, diagnosing understanding of facts, concepts, learned items, knowledge, subject matter, competencies, abilities, standards, claimed understanding, agreements, representations, contractual terms, organizational policies, prescribed procedures, dangers, potential risks, assumption of risks, intended actions, likely or possible consequences or any other talent or type of dexterity or testable skill, knowledge or aptitude whose clarification and/or measurement could have relevance to the completion of a business transaction and/or the granting of an informational request while being a means to design training and/or education on said subject matter, comprising:
using an input and display device to administer a test and to obtain answers from an individual or group to determine the appropriateness of making available a product, service and/or granting an informational request; and
limiting fiduciary liability exposure and/or clarifying relevant elements of the commercial transaction or informational request by displaying and allowing selection of those options and alternatives determined to be understood by the individual or group based upon the answers to the test, and/or responsibly chosen with documentable advice provided by a competent advisor, and/or yielding a checklist, questionnaire or other legal or clarifying document or repository of information whose completion will provide documentable evidence of fiduciary stewardship involving the business transaction or informational request.
